(19) United States
(12) Patent Application Publication
(10) Pub. No.: US 2022/0028224 A1
(43) Pub. Date: Jan. 27, 2022

(54) SYSTEMS AND METHODS FOR CUSTOMIZED ODDS BETTING AND INTERFACES FOR THE SAME

(71) Applicant: Sports ReUp, LLC, Dover, DE (US)

(72) Inventors: Bryan PROSKEY, Shorewood, IL (US); Jonathon PROSKEY, Naperville, IL (US)

(73) Assignee: Sports ReUp, LLC, Dover, DE (US)

(21) Appl. No.: 17/383,349

(22) Filed: Jul. 22, 2021

Related U.S. Application Data
(60) Provisional application No. 63/055,632, filed on Jul. 23, 2020.

(51) Int. Cl. G07F 17/32; G06Q 50/34

(52) U.S. Cl. CPC G07F 17/3288; G06Q 50/34; G07F 17/323

(57) ABSTRACT

Systems and methods are provided for generating a customized bet between a user and a peer such that a user and/or a peer may modify bet parameters to result in a wager that is agreeable by both parties. The betting system involves a user application used by a user to connect with a web-based betting platform and also connect with peers running user applications. A user may select a peer to connect with, select a game or event to bet on, and select a team or individual participating in the game or event to bet on. A user or a peer may determine whether to make a straight bet or bet on the point spread and then may alter the point spread and or odds as desired. The user and peer may finalize the bet by confirming that they agree to the bet parameters.

### CROSS-REFERENCE TO RELATED APPLICATIONS

This application claims the benefit of priority of U.S. Provisional Patent Application Ser. No. 63/055,632, filed Jul. 23, 2020, the entire contents of which are incorporated herein by reference.

### TECHNICAL FIELD

The present disclosure relates, in general, to a system for making bets, for example, a sports betting system, and more specifically to a system with customizable wagering parameters such as customizable odds.

### BACKGROUND

For nearly as long as civilization has been involved in organized sports, individuals have bet on the outcome of these games, matches, events, etc. One way of betting on sports involves merely selecting a team or individual that will be victorious. For example, two individuals bet on the outcome of a baseball game, each individual selecting a team. The individuals may further agree upon an amount to bet. Upon completion of the game, the individual that selected the losing team will be obligated to pay the agreed upon amount to the individual that selected the winning team.

Yet another, and more complex, way to bet on a game involves point spread betting. The point spread is an amount of points that a team favored to win must achieve. For example, in basketball the point spread may be 6.5 points. Betting with the spread means that an individual is betting that the favored team will win by more than 6.5 points. Betting against the spread means that an individual is betting that the favored team will lose or will win but by six points or fewer.

In both types of betting the odds may be adjusted. In the simplest case, the odds may be one-to-one, meaning that either individual will receive the same amount if they win. Alternatively, odds may be adjusted to offset the likelihood of winning. For example, in the basketball game, if one team is significantly better than the other team, the individuals may agree to 2:1 odds. In this case, the individual that selected the underdog will win two times the agreed upon amount if the underdog wins, but will only lose one times the agreed upon amount if the favored team wins.

In modern times, betting institutions (e.g., Las Vegas casinos) publish odds for certain sporting events. These institutions spend a significant amount of resources on determining which teams or participants have the upper hand and even take into account factors such as weather, health, injuries, etc. It is not uncommon for individuals who decide to make a bet to adopt the Las Vegas betting odds for a particular wager. These betting institutions provide odds for both the straight up style of betting as well as the spread variety.

As odds and the likelihood of one side being victorious is not a perfect science but instead is based on a plurality of factors, intangibles, and even intuition, the betting institutions do not provide an explanation for how they arrived at the determined odds. Accordingly, individuals have to choose to either bet with even odds (1:1) or adopt the odds published by these betting institutions. If the individuals that desire to may a bet choose to go with published odds or choose to come up with their own odds, betting becomes more complex as it is difficult to remember the agreed upon odds, especially considering that published odds are always in flux.

In view of the foregoing limitations of previously-known systems and methods, it would be desirable to have an automated betting platform that permits individuals to make a wager, view published odds, customize odds, and memorialize the agreed upon bet.

### SUMMARY OF THE INVENTION

Provided herein are systems and methods for generating a customized bet between a user using a user device and one or more peers using peer devices. The betting system may involve a user device, one or more peer devices, one or more servers, and one or more databases. Specifically, systems and methods are provided for connecting a user with one or more peers, selecting an event, game, or match to bet on, selecting bet parameters such as odds for the bet and/or a point spread, selecting an amount to bet on, and confirming a bet.

The betting system may comprise instructions stored on at least one server that, when executed, cause the server to transmit or receive data for one or more user devices or peer devices. The server may transmit a plurality of peers to connect with, a plurality of events to select from, and/or a plurality of bet types to select from to a user device. The server may also receive a selected peer of the plurality of peers to connect with, a selected event of the plurality of events to select from as well as a selected team corresponding to the selected event, and/or a selected bet type of the plurality of bet types to select from the user device. Similarly, the server may transmit at least one bet parameter corresponding to the selected event to a user device. The server may then receive the at least one modified bet parameter from the user device, the modified bet parameter being different from the bet parameter transmitted to the user device. At least one of the modified bet parameters may be used to generate a customized bet by the user device. The server may receive a customized bet and confirmation that the customized bet, that includes at least one modified bet parameter, is correct from the user device. The server may then transmit the customized bet to the peer device and receive confirmation that the customized bet is acceptable from the peer device.

A system for generating a customized bet may permit a user to select a peer to make a wager with, select a game, match, or event to bet on, select a team or individual involved in the selected game, match, or event to bet on, determine whether the bet will be a straight bet or involve a point spread, select a point spread and/or odds, and select an amount to bet on. Once the bet parameters are selected, both the user and the peer may confirm the parameters to finalize the bet.

The betting system may be in communication with a desired betting institution and include a default point spread value and/or a default odds value for a selected game, match, or event. The betting system may further include an adjustor running on a server that uses a customized formula to alter the odds based on the point spread selected. This customized formula may be based off historic data involving point spreads, odds, and outcomes in similar games, matches, or events.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is an illustration of exemplary components for executing a betting system.

FIGS. 2A-2D are exemplary functional blocks representing the hardware and software components of, respectively, a user device, peer device, administrator device, and server.

FIG. 3 is an exemplary process for implementing a betting system to connect a user using a user device and a peer using a peer device and facilitate a customizable wager.

FIGS. 4A-4B are exemplary interfaces for selecting an event to bet on.

FIG. 5 is an exemplary user interface for selecting a bet type.

FIG. 6 is an exemplary user interface for customizing a point spread bet.

FIG. 7 is an exemplary user interface to select a desired amount to bet.

FIG. 8 is an exemplary user interface to confirm and finalize a customized bet and bet parameters.

The foregoing and other features of the present invention will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION OF THE INVENTION

The present invention is directed to a betting system involving a betting platform run on one or more servers, user applications running on a plurality of user devices in communication with the server, and one or more administrator devices each running an administrator application. A plurality of devices may run the user applications to communicate and interact with the betting platform over the Internet. Similarly, the one or more administrator devices may each run an administrator application to communicate with and interact with the betting platform over the Internet. Via the user application together with the betting platform, users of the betting system may connect with one another over the Internet and bet on various events, matches, games, and/or competitions. The bets may be customized using the user application and betting platform to customize the odds and other betting parameters (e.g., the spread).

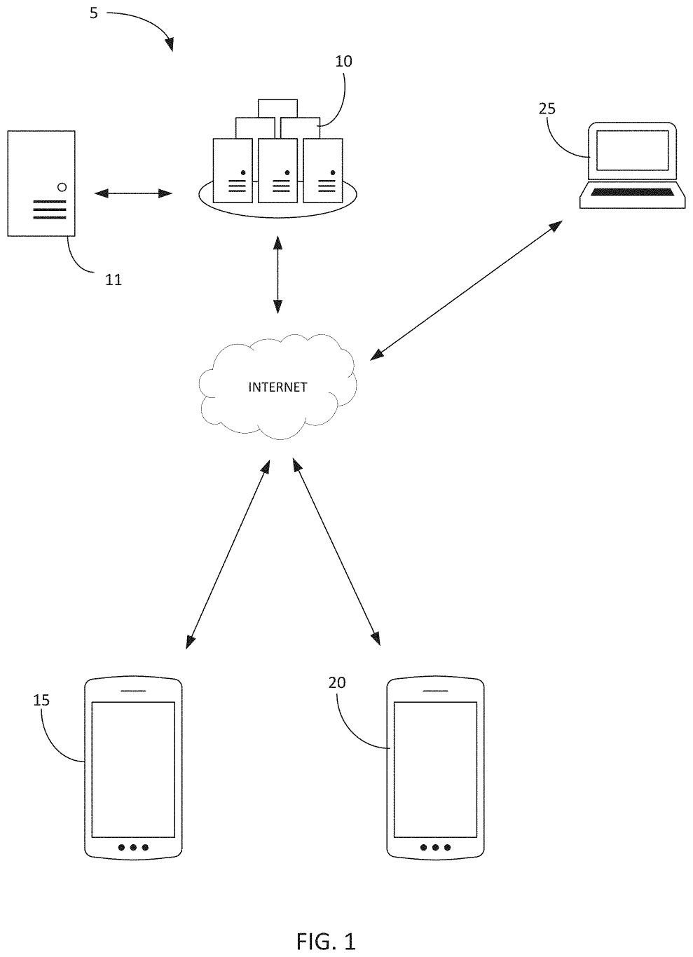

Referring now to FIG. 1, exemplary components for executing betting system 5 are illustrated. Specifically, as is shown in FIG. 1, betting system 5 may include server 10, user device 15, peer device 20, and administrator device 25. It is of course understood that betting system 5 may include more than two user and/or peer devices, more than one server, and/or more than one administrator device.

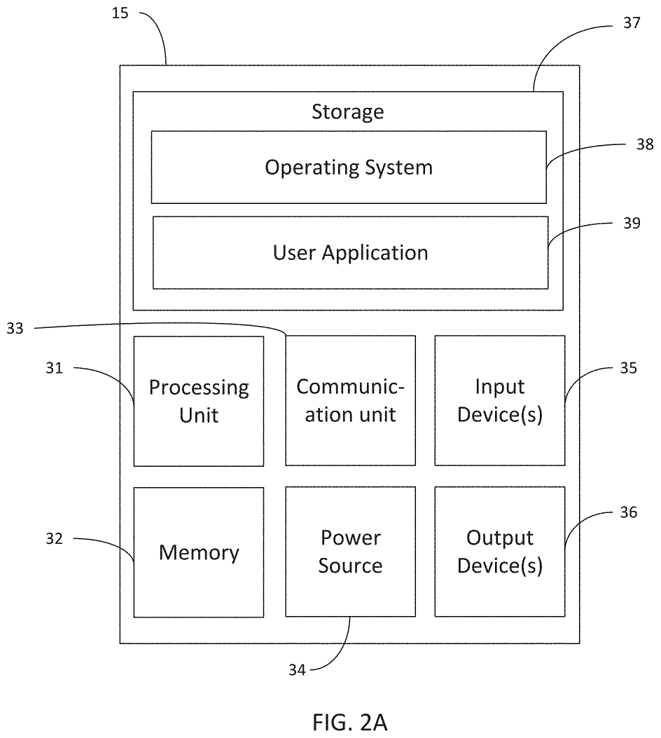

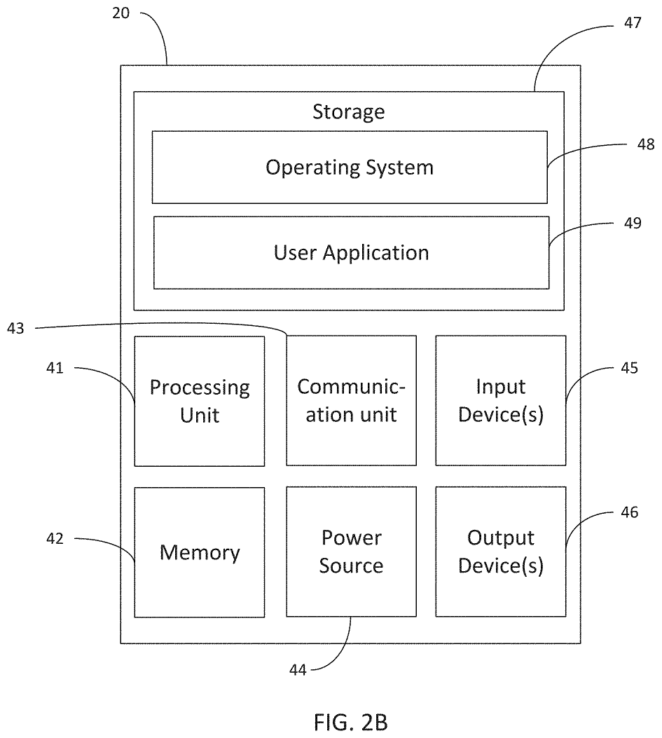

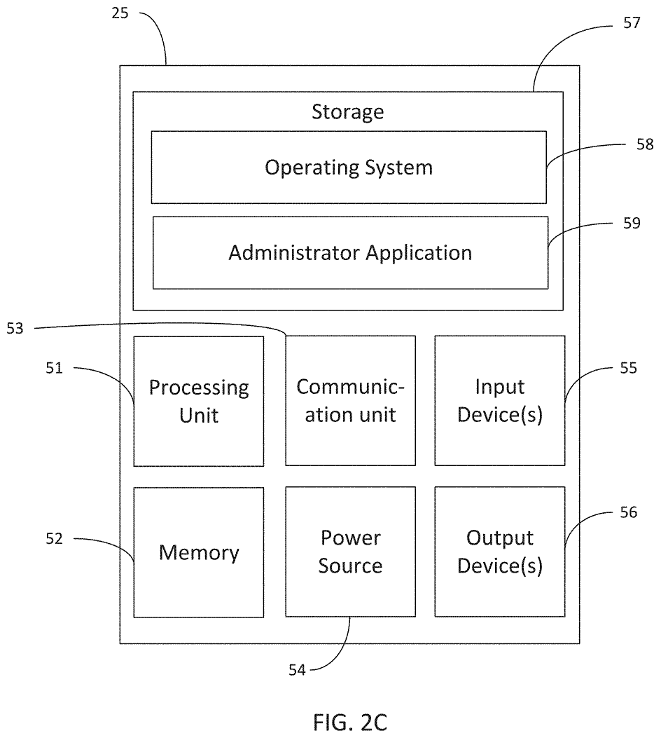

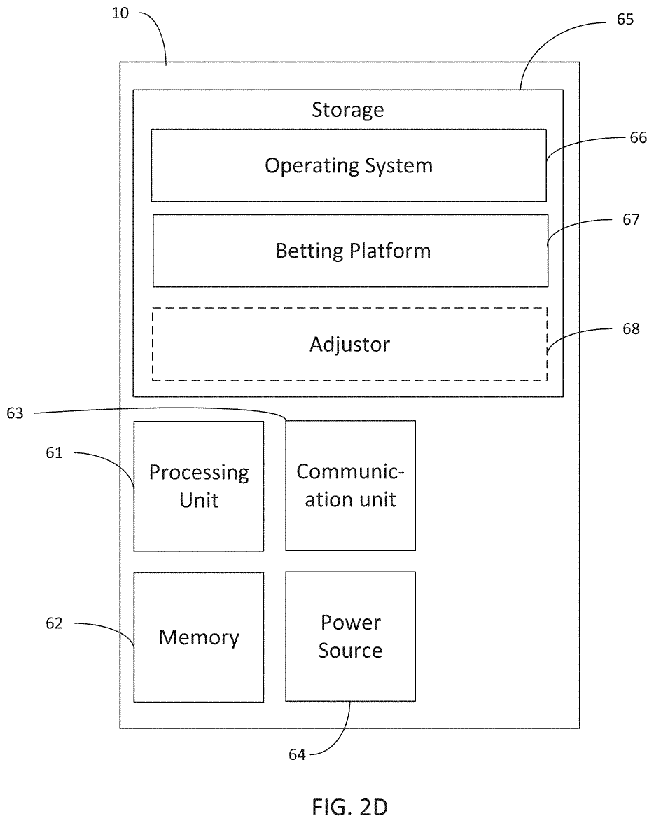

User device 15 is a computing device (e.g., smartphone, laptop, desktop, tablet, smartwatch, etc.) having the components described below with reference to FIG. 2A and the functionality described herein. User device 15 running user application 39 may connect with server 10 running betting platform 67 via any well-known wired or wireless connection. For example, user device 15 may connect to the Internet using well known technology (e.g., WiFi, cellular, cable/coaxial, and/or DSL) and may communicate with server 10 over the Internet. Via user application 39, a user may communicate and interact with betting platform 67 and other devices in betting system 5 (e.g., peer device 20).

Peer device 20 is a computing device (e.g., smartphone, laptop, desktop, tablet, smartwatch, etc.) having the components described below with reference to FIG. 2B and the functionality described herein. Peer device 20 running user application 49 may connect with server 10 running betting platform 67 via any well-known wired or wireless connection. For example, peer device 20 may connect to the Internet using well known technology (e.g., WiFi, cellular, cable/coaxial, and/or DSL) and may communicate with server 10 over the Internet. Via user application 49, a peer may communicate and interact with betting platform 67 and other devices in betting system 5 (e.g., user device 15 and/or other peer devices).

Administrator device 25 is a computing device (e.g., laptop, smartphone, desktop, tablet, smartwatch, etc.) having the components described below with reference to FIG. 2C and the functionality described herein. Administrator device 25 running administrator application 59 may connect with server 10 running betting platform 67 via any well-known wired or wireless connection. For example, administrator device 25 may connect to the Internet using well known technology (e.g., WiFi, cellular, cable/coaxial, and/or DSL) and may communicate with server 10 over the Internet. Via administrator application 59, an administrator may communicate and interact with betting platform 67 and other devices in betting system 5 (e.g., user device 15 and/or other peer devices).

Server 10 is preferably one or more servers having the components described below with reference to FIG. 2D and the functionality described herein. Server 10 may run betting platform 67 and communicate with a plurality of user devices (e.g., user device 15 and peer device 20) and one or more administrative devices (e.g., administrative device 25). As will be readily apparent to one skilled in the art, server 10 may include a plurality of servers located in a common physical location or in different physical locations. In a preferred embodiment, server 10 is located in a different, remote location (e.g., on the cloud) than user device 15, peer device 20 and administrator device 25, although server 10 and administrator device 25 may be located in a common location (e.g., on a local area network (LAN)).

Server 10 may optionally communicate with drive 11, which may be one or more drives having memory dedicated to storing digital information unique to a certain patient, professional, facility, and/or device. For example, drive 11 may include, but is not limited to, volatile (e.g. random-access memory (RAM)), non-volatile (e.g. read-only memory (ROM)), flash memory, or any combination thereof. Drive 11 may be incorporated into server 10 or may be separate and distinct from server 10 and may communicate with server 10 over any well-known wireless or wired connection.

Referring now to FIGS. 2A-2D, exemplary functional blocks representing the hardware and software components of user device 15, peer device 20, administrator device 25, and server 10 are shown. Referring now to FIG. 2A, hardware and software components of user device 15 may include one or more processing unit 31, memory 32, storage 37, communication unit 33, power source 34, input device 35, and output device 36.

Processing unit 31 may be one or more processors configured to run operating system 38 and user application 39 and perform the tasks and operations of user device 15 set forth herein. Memory 32 may include, but is not limited to, volatile (e.g. random-access memory (RAM)), non-volatile (e.g. read-only memory (ROM)), flash memory, or any combination thereof. Communication unit 33 may receive and/or transmit information to and from other components in betting system 5 including, but not limited to, peer device 20, administrator device 25, and server 10. Communication unit 33 may be any well-known communication infrastructure facilitating communication over any well-known wired or wireless connection, including over any well-known standard such as any IEEE 802 standard. Power source 34 may be a battery or may connect user device 15 to a wall outlet or any other external source of power. Storage 37 may include, but is not limited to, removable and/or non-removable storage such as, for example, magnetic disks, optical disks, or tape.

Input device 35 may be one or more devices coupled to or incorporated into user device 15 for inputting data into user device 15. Input device 35 may further include a keyboard, a mouse, a pen, a sound input device (e.g., microphone), and/or a touch input device (e.g., touch pad or touch screen), for example. Output device 36 may be any device coupled to or incorporated into user device 15 for outputting or otherwise displaying data. Output device 36, may further include speakers and/or a printer, for example.

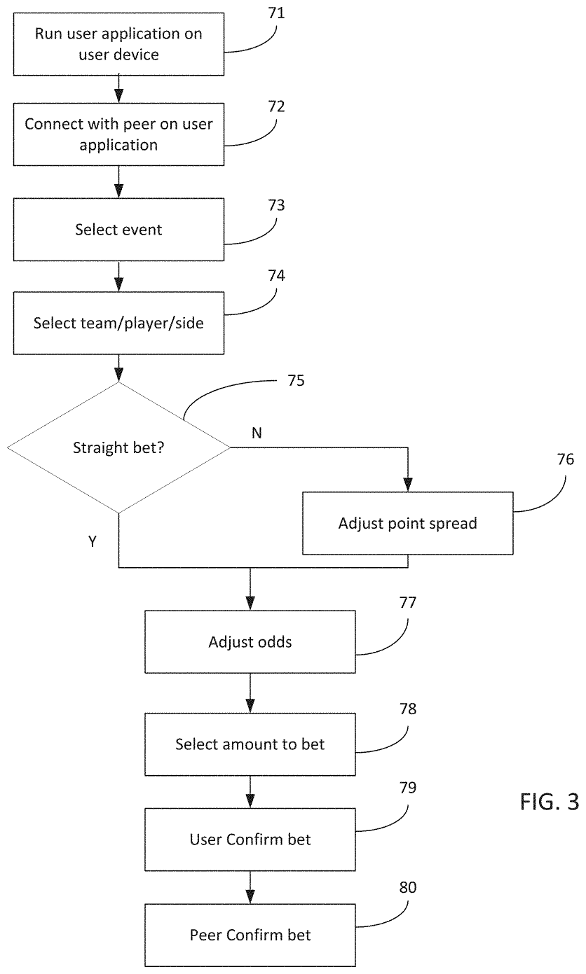

User application 39 may be stored in storage 37 and executed on processing unit 31. User application 39 may be a software application and/or software modules having one or more sets of instructions suitable for performing the operations of user device 15 set forth herein, including facilitating the exchange of information with server 10 running betting platform 67. For example, user application 39 may coordinate with betting platform 67 to customize a bet with a peer device, as described in greater detail below with respect to FIG. 3. Operating system 38 may be stored in storage 37 and executed on processing unit 31. Operating system 38 may be suitable for controlling the general operation of user device 15 and may work in concert with user application 39 to achieve the functionality of user device 15 described herein. User device 15 may also optionally run a graphics library, other operating systems, and/or any other application programs. It of course is understood that user device 15 may include additional or fewer components than those illustrated in FIG. 2A and may include more than one of each type of component.

Referring now to FIG. 2B, hardware and software components of peer device 20 may include one or more processing unit 41, memory 42, storage 47, communication unit 43, and power source 44, input device 45, and output device 46. Processing unit 41 may be one or more processors configured to run operating system 48 and user application 49 and perform the tasks and operations of peer device 20 set forth herein.

User application 49 may be the same as user application 39 and may be stored in storage 47 and executed on processing unit 41. User application 49 may be a software application and/or software modules having one or more sets of instructions suitable for performing the operations of peer device 20 set forth herein, including facilitating the exchange of information with server 10 running betting platform 67. For example, user application 49 may coordinate with betting platform 67 to customize a bet with peer device 20 and/or a user device, as described in greater detail below with respect to FIG. 3. Operating system 48 may be the same as operating system 38 and may be stored in storage 47 and executed on processing unit 41. Operating system 48 may be suitable for controlling the general operation of peer device 20 and may work in concert with user application 49 to achieve the functionality of peer device 20 described herein.

Memory 42 may be the same as memory 32. Communication unit 43 may be the same as communication 33. Power source 44 may be the same as power source 34. Storage 47 may be the same as storage 37. Input device 45 may be the same as input device 35. Output device 46 may be the same as output device 36. Peer device 20 may also optionally run a graphics library, other operating systems, and/or any other application programs. It of course is understood that peer device 20 may include additional or fewer components than those illustrated in FIG. 2B and may include more than one of each type of component. It is further understood that peer device 20 may have the same components and functionality as user device 15.

Referring now to FIG. 2C, hardware and software components of administrator device 25 may include one or more processing unit 51, memory 52, storage 57, communication unit 53, and power source 54, input device 55, and output device 56. Processing unit 51 may be one or more processors configured to run operating system 58 and administer application 59 and perform the tasks and operations of administrator device 25 set forth herein.

Memory 52 may be the same as memory 32. Communication unit 53 may be the same as communication 33. Power source 54 may be the same as power source 34. Storage 57 may be the same as storage 37. Input device 55 may be the same as input device 35. Output device 56 may be the same as output device 36.

Administrator application 59 may be stored in storage 57 and executed on processing unit 51. Administrator application 59 may be a software application and/or software modules having one or more sets of instructions suitable for performing the operations of administrator device 25 set forth herein. Administrator application 59 may facilitate the exchange of information with server 10 running betting platform 67. Administrator application 59 may be the same or similar to user application 39 and user application 49 but may include access to features and/or settings not available to user application 39 and user application 49. For example, administrator application running on administrator device 25 may have permission to alter settings of betting platform 67 and/or to restrict access of certain user devices and/or users to betting platform 67. Administrator application 59 may have access to some or all betting records and transactions. It is understood that administrator application 59 may alter betting platform 67, user application 39 and/or user application 49 in any way.

Operating system 58 may be the same as operating system 38 and may be stored in storage 57 and executed on processing unit 51. Operating system 58 may be suitable for controlling the general operation of administrator device 25 and may work in concert with administrator application 59 to achieve the functionality of administrator device 25 described herein. Administrator device 25 may also optionally run a graphics library, other operating systems, and/or any other application programs. It of course is understood that administrator device 25 may include additional or fewer components than those illustrated in FIG. 2C and may include more than one of each type of component.

Referring now to FIG. 2D, hardware and software components of server 10 may include one or more processing unit 61, memory 62, storage 65, communication unit 63, and power source 64. Processing unit 61 may be one or more processors configured to run operating system 66, betting platform 67, and, optionally, adjustor 68 and perform the tasks and operations of server 10 set forth herein.

Memory 62 may include, but is not limited to, volatile (e.g. random-access memory (RAM)), non-volatile (e.g. read-only memory (ROM)), flash memory, or any combination thereof. Communication unit 63 may receive and/or transmit information to and from other components in betting system 5 including, but not limited to, user device 15, peer device 20, and/or administrator device 25. Communication unit 63 may be any well-known communication infrastructure facilitating communication over any well-known wired or wireless connection, including over any well-known standard such as any IEEE 802 standard. Power source 64 may be a battery or may connect server to a wall outlet or any other external source of power. Storage 65 may include, but is not limited to, removable and/or non-removable storage such as, for example, magnetic disks, optical disks, or tape.

Betting platform 67, operating system 66, and, optionally, adjustor 68 may be stored in storage 65 and executed on processing unit 61. Betting platform 67 may be a software application and/or software modules having one or more sets of instructions suitable for performing the operations of server 10 set forth herein. Betting platform 67 running on server 10 may communicate and work in concert with user application 39, user application 49, and administrator application 59 to provide a platform upon which a user may connect with a peer and agree upon a customized wager as forth in FIG. 3. Adjustor 68 may be a software application and/or software modules having one or more sets of instructions and/or algorithms suitable for automatically adjusting odds based on selected parameters, such as a point spread, as explained in greater detail below. It is understood that adjustor 68 is optional and may be a standalone application or may be incorporated into betting platform 67.

Operating system 66 may be suitable for controlling the general operation of server 10 and may work in concert with administrator application 59 to achieve the functionality of server 10 described herein. Server 10 may also optionally run a graphics library, other operating systems, and/or any other application programs. It of course is understood that server 10 may include additional or fewer components than those illustrated in FIG. 2 Dand may include more than one of each type of component.

Referring now to FIG. 3, an exemplary process for implementing betting system 5 to connect a user using user device 15 and a peer using peer device 20 and facilitate a customizable wager is illustrated. FIG. 3 further shows the flow of information between a front end (i.e., user application 39 running on user device 15 and user application 49 running on peer device 20) and a back end (i.e., betting platform 67 running on server 10) of betting system 5. It is understood that the steps shown in FIG. 3 are exemplary and may be executed in a different order. For example, steps 72-78 may be executed out of order.

As is shown in FIG. 3, the process set forth in FIG. 3 may be initiated at step 71 by running user application 39 on user device 15. This step may further include initial steps involving downloading user application 39 to user device 15, registering and creating a user profile corresponding to the respective user, and accessing user application 39 by generating and submitting a password or pin associated with the user profile on user device 15. Peers may employ a similar process involving generating a profile and accessing user application 49 on peer device 20. The user profile may include information about that user's or peer's favorite teams, contacts, and/or payment information (e.g., credit card information).

Upon running user application 39 on user device 15 and accessing user application 39, at step 72, a user may find a peer device from a list of peers to connect with to make a bet. A user using user application 39 may select multiple peers from a list of peers as contacts which may be saved by user application 39 and/or betting platform 67. Alternatively, or in addition to, a user using user application 39 may enter a phone number or email address of a registered user to connect with and user application 39 may coordinate with betting platform 67 to connect with the desired user. This step may involve a user using user device 15 running user application 39 sending a request via betting platform 67 to peer device 20 running user application 49. A peer may then accept or deny the request using user application 49. If the request is accepted, the user and the peer may proceed with customizing a bet.

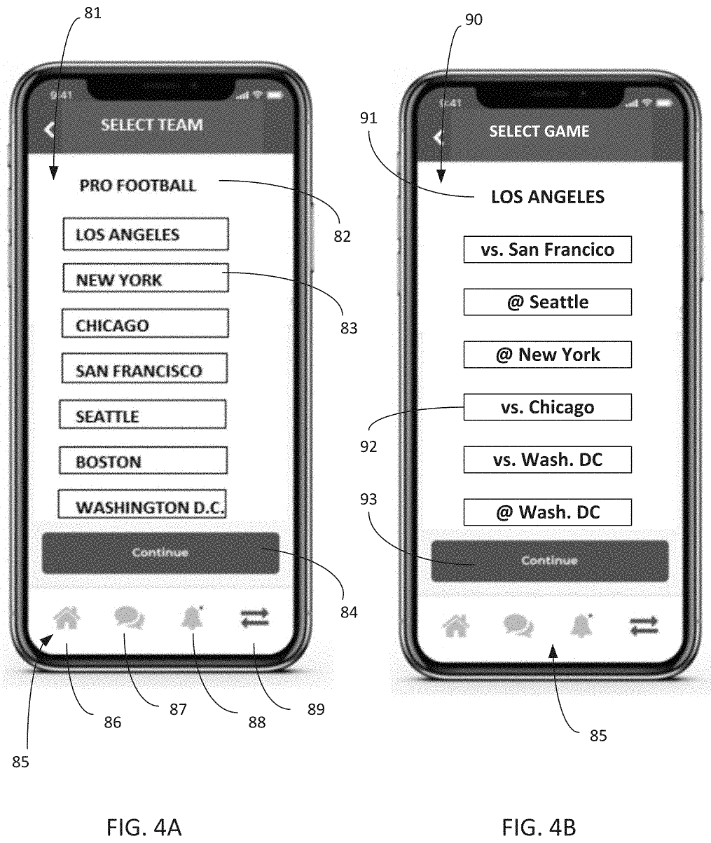

At step 73, either a user using user application 39 or a peer using user application 49 may select an event to bet on. This step may alternatively occur before step 72. Referring now to FIGS. 4A and 4B, exemplary interfaces are shown for selecting an event to bet on. As is shown in FIG. 4A, to select an event, a user using user application 39 or a peer using user application 49 may select a team or group to bet on using user interface 81. A user or peer may initially pick a sport to bet on (e.g., professional football, fantasy football). Next, a user or peer may select team button 83 from a list of teams from the professional or fantasy sport. For example, the user applications may communicate with another application (e.g., Yahoo fantasy football application) to retrieve information on a fantasy team and/or fantasy league. Once the desired team is selected, a user or peer may select continue button 84 to select the desired team and view games or matches for that team.

User interface 81 may further include navigation buttons 85, which may include home button 86, chat button 87, alarm button 88, and/or transactions button 89. Home button 86 may take the user or peer to a home screen. Chat button 87 may take the user to a chat interface to message peers. Alarm button 88 may take the user to an alarm interface to set reminders or manage alerts (e.g., game time reminders, alert of a new bet, etc.). Transactions button 89 may take the user to a transactions page showing all pending and past bets and relevant information.

Referring now to FIG. 4B, to select a game or match involving the desired team, a user using user application 39 or a peer using user application 49 may select a game or match to bet on using user interface 90. User interface 90 may list selected team 91 and upcoming games or matches for the selected team and a user or peer may select a game or match using event button 92. To confirm the selected event, a user or peer may then select continue button 93. User interface 90 may similarly include navigation buttons 85.

Referring again to FIG. 3, once the event is selected at step 73, a user may select a team, player, or side to bet on. A user may select a plurality of players on a real team, e.g., the Chicago Bears, a fantasy team, or may select a plurality of players from various teams to form a fantasy team. User application 39 may select the team selected at step 74 as the default team to bet on. Once the user completes steps 73 and 74, the selected event and the desired team, player, or side selected by the user may be shared with the peer connected with at step 72. For example, the peer may receive an alert that an event has been proposed.

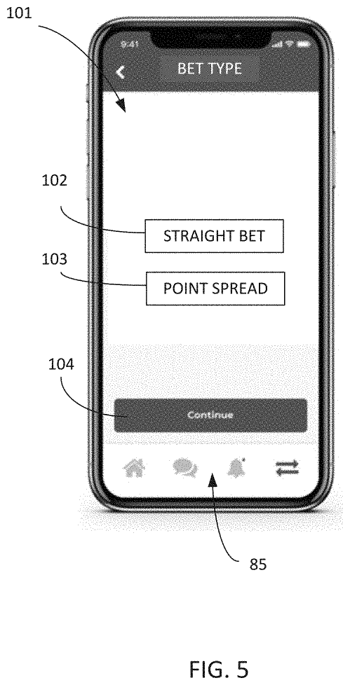

At decision 75, user application 39 may generate user interface 101 shown in FIG. 5 for selecting the bet type. Using user interface 101, a user may select a straight bet using button 102 or a point spread bet using button 103. A straight bet will not involve a point spread and instead the user/peer that correctly selected the winner of the event will win the bet. A point spread bet will involve a point spread. A user may select a straight bet at decision 75 by selecting button 102 and confirming the selection by engaging continue button 104. Alternatively, a user may select a point spread bet at decision 75 by selecting button 103 and confirming the selection by engaging continue button 104.

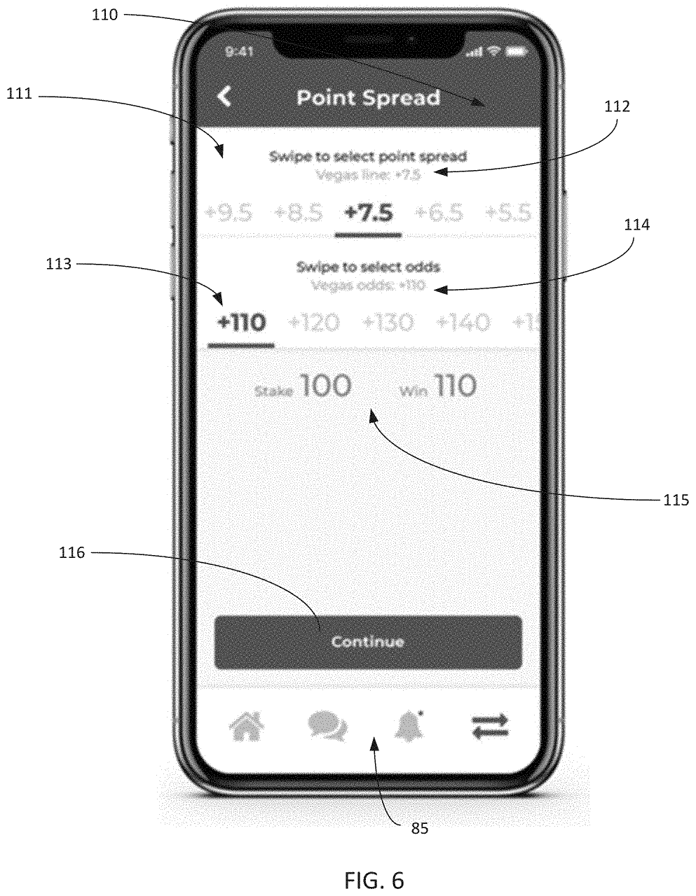

Referring again to FIG. 3, if a straight bet is not selected at decision 75 (e.g., the point spread bet is selected using button 103), at step 76 a point spread bet may be customized. Referring now to FIG. 6, user application 39 may generate user interface 110 for customizing a point spread bet. As is shown in FIG. 6, user interface 110 may include point spread indicator 111. Point spread indicator 111 may list several point spread options in reverse numerical order and may show the selected point spread in bold and/or underline. Alternatively, point spread indicator may only show a selected point spread. For example, point spread indicator 111 may list point spreads such as +9.5, +8.5, +7.5, +6.5, +5.5, etc. To change the point spread, a user may scroll through different point spread options or may select or type in a different point spread option (e.g., using a touch screen).

User interface 110 may preselect a default value for point spread indicator 111 for the selected game, match, or event. For example, user interface 110 may display current point spread indicator 112 according to a certain betting institution or collection of betting institutions. Betting system 5 may be in constant communication with one or more servers or data bases of one or more betting institutions and may display and adjust, in real time, current point spread indicator 112 for a given game, event, or match. Point spread indicator 111 may show, as the default selected value, the value in current point spread indicator 112.

User interface 110 may also display odds indicator 113, which may list several odds for the bet. For example, odds indicator 113 may list odds in numerical order such as +110, +120, +130, +140, +150, etc. Odds indicator 113 may show selected odds in bold and/or underline. Alternatively, odds indicator 113 may only show selected odds. Referring again to FIG. 3, at step 77, a user may adjust the odds by, for example, scrolling through different odds options or typing in a different odds (e.g., using a touch screen).

User interface 110 may preselect a default value for odds indicator 113 for the selected game, match, or event. For example, user interface 110 may display current odds indicator 114 according to a certain betting institution or collection of betting institutions. As explained above, betting system 5 may be in constant communication with one or more servers or databases of one or more betting institutions. Betting system 5 may display and adjust, in real time, current odds indicator 114 for a given game, event, or match. Odds indicator 113 may show, as the default selected value, the value in current odds indicator 112.

The odds may correspond, at least initially, to a point spread value. For example, the value of current odds indicator 114 may be a value determined by a desired betting institution for a given point spread value. Typically, betting institutions will provide a point spread value for 1:1 odds. The default values for odds indicator 113 and point spread indicator 111 may be the point spread value determined by a desired betting institution to correspond to 1:1 odds. A user may then select any other point spread value and any other odds value to customize the bet as desired. User interface 110 may show the selected odds at odds display 115. For example, odds display 115 may show the stake value (e.g., 100) and the win value (e.g., 110) according to the odds selected using odds indicator 113. In this case, if the user bets $100 dollars, the user will lose $100 dollars if they lose the bet but will win $110 dollars if they win the bet.

In one example, betting system 5 may automatically adjust the odds according to the point spread selected using adjustor 68. For example, using the point spread value determined by a desired betting institution to have 1:1 odds (or nearly 1:1 odds), or any other point spread value corresponding to different odds, adjustor 68 may determine how the odds value fluctuates as the point spread is changed. Adjustor 68 may scale (i.e., change) the odds proportionally with the point spread or may scale the odds according to a desired formula. For example, adjustor 68 may analyze historic data for similar games or events (e.g., using artificial intelligence) to generate a formula for scaling the odds as the point spread is changed.

Upon selecting a desired point spread using point spread indicator 111 and selecting desired odds using odds indicator 113, the user may select continue button 116 to share the proposed betting parameters (e.g., point spread and/or odds) with the peer it connected with at step 72. User interface 110 may similarly include navigation buttons 85.

If the user at decision 75, instead elects to make straight bet (e.g., not involving the point spread) using user interface 101, at step 77 the user will then adjust the odds for the bet using a user interface similar to user interface 110 but without point spread indicator 111 and current point spread indicator 112. In this case, the value in odds indicator 113 and current odds indicator 114 will not correspond to a point spread. Instead, the value in current odds indicator 114 may correspond to the straight bet odds at a desired betting institution for that event, match, or game. The user may then change the odds as desired as explained above.

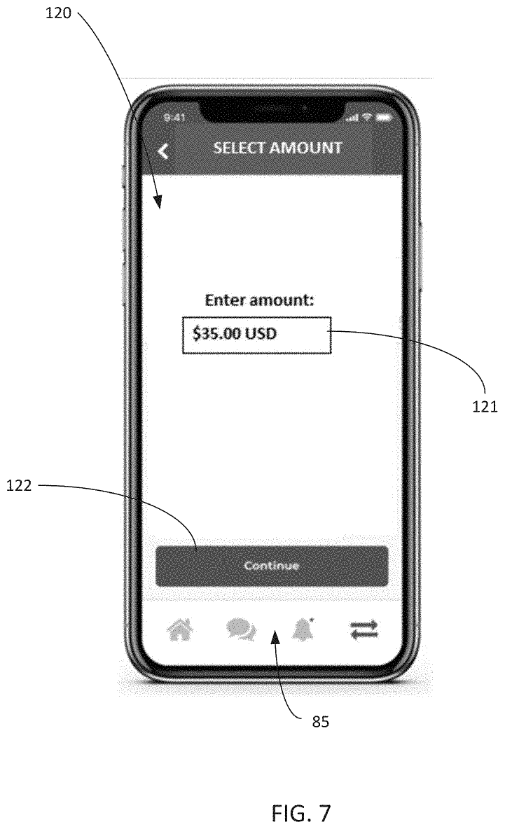

Upon customizing the point spread and/or odds in steps 75-77, a user may then select the desired amount to bet at step 78. Referring now to FIG. 7, user interface 120 is illustrated. As is shown in FIG. 7, user interface 120 may include amount window 121 in which a user may select a desired amount to bet. The user may type in the desired amount in (e.g., using a touchscreen or keypad). User interface 120 may further include a current balance for that user, other pending bets and the amounts involved in those bets, and/or a transaction history with the peer connected with at step 72. User interface 110 may similarly include navigation buttons 85. Upon selecting the desired amount for the bet, the user may select continue button 122 to confirm the amount.

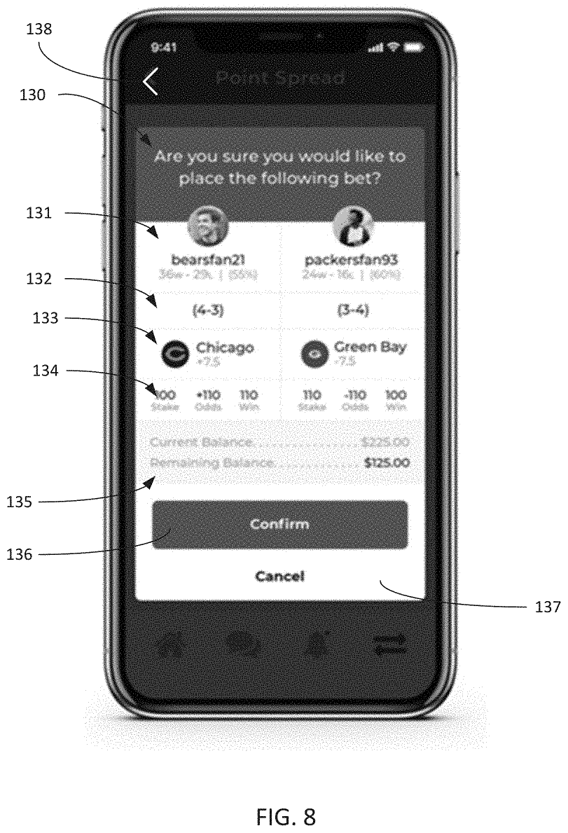

Referring again to FIG. 3, at step 79 a user may confirm the bet to finalize the customized bet and bet parameters (e.g., odds, point spread, amount). User interface 130, illustrated in FIG. 8, may be generated after the user has selected the desired bet parameters. As is shown in FIG. 8, user interface 130 may include a statement confirming that the user would like to place the bet. User interface 130 may further include user and peer indicator 131 showing the name and/or user name of the user and peer(s) involved in the bet. User and peer indicator 131 may further include the number of wins and losses of each user and/or a win-to-loss ratio. User interface 131 may further include record indicator 132 that displays the win-to-loss record for the team or individuals participating in the selected game, match, or event.

User interface 131 may further include spread indicator 133, if a point spread bet is involved. Point spread indicator 133 may show the teams or individuals involved in the game, match, or event and the selected point spread corresponding to each team or individual. Alternatively, or additionally, user indicator may have a selected team or individual showing the team or individual that each user selected for the customized bet. User interface 131 may also include odds indicator 134 showing the odds selected for the customized bet for each user. Odds indicator 134 may display for each user stake, odds, and wins values corresponding to the selected odds. User interface 131 may further include balance indicator 135 showing the current balance for that user and a remaining balance after the customized bet is accepted by both users. The pending amount will be subtracted from the current balance to create the reaming balance amount.

If the bet parameters and other values shown in user interface 130 are accurate, the user may select confirm button 136 to confirm the customized bet. Alternatively, if the user would like to cancel the bet or otherwise modify the bet, the user may select cancel button 137. To modify the bet parameter, a user may select back button 138 to repeat all or a portion of the process in steps 72-78 to correct or modify the bet as desired.

Referring again to FIG. 3, if the user confirms the bet at step 79 (e.g., using confirm button 136 on user interface 130) a message including the bet parameters will be sent from server 10 to the peer device selected at step 72. In response to the message, peer device 20 running user application 49 may generate user interface 140 (not shown) that is identical or substantially similar to user interface 130. At step 80, a peer using user interface 140 may confirm that the user consents to the bet and bet parameters by pressing the confirm button. Upon pressing the confirm button the bet will be finalized and complete. The user and the peer may receive a confirmation message that the bet is complete.

If the peer does not want to complete the bet, the peer may cancel or modify the bet in the same manner as the user described above with respect to FIG. 8. User interface 140 and/or user interface 130 may further include a modify button. The peer may change the bet parameters in the same manner as described above with respect to steps 73-78. Upon selecting new bet parameters, the peer may confirm the bet upon which point the new bet parameters may be sent to the user device to confirm. It is understood that the user and the peer may take turns altering the bet parameters until parameters can be agreed upon.

Once bet parameters are agreed upon and both the user and the peer have confirmed the bet, the bet can no longer be altered. It is understood that the point spread and odds at a desired betting institution may continue to change after the bet is confirmed. However, the bet parameters will remain unchanged once the bet is confirmed. At the completion of the bet, betting system 5 may cause the desired amount selected at step 78 to be transferred to the user or peer that won the bet. This process may involve money transfer to and from a user account or a bank account associated with each user in that user's profile.

It should be understood that any of the operations described herein above may be implemented at least in part as computer-readable instructions stored on a computer-readable memory. Upon execution of the computer-readable instructions by a processor, the computer-readable instructions may cause a node to perform the operations. It will of course be understood that the embodiments described herein are illustrative, and components may be arranged, substituted, combined, and designed in a wide variety of different configurations, all of which are contemplated and fall within the scope of this disclosure.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. For example, it is understood that the steps in FIG. 3 may be executed in a different order. It is intended that the scope of the invention be defined by the claims.

What is claimed is:

1. A system for customizing a bet, the system comprising instructions stored on at least one server, the instructions configured to, when executed, cause the at least one server to:
transmit, to a user device, a plurality of peers to connect with;
receive, from the user device, a peer of the plurality of peers to connect with;
transmit, to the user device, a plurality of events to select from;
receive, from the user device, a selected event of the plurality of events and a selected team corresponding to the selected event;
transmit, to the user device, a plurality of bet types to select from;
receive, from the user device, a selected bet type of the plurality of bet types;
transmit, to the user device, at least one bet parameter corresponding to the selected event;
receive, from the user device, at least one modified bet parameter, the at least one modified bet parameter different from the at least one bet parameter transmitted to the user device, the at least one modified bet parameter used to generate a customized bet by the user device;
receive, from the user device, the customized bet and confirmation that the customized bet including the at least one modified bet parameter is correct;
transmit, to the peer device, the customized bet; and
receive, from the peer device, confirmation that the customized bet is acceptable.

2. The system of claim 1, wherein receiving at least one modified bet parameter comprises receiving a point spread value corresponding to the selected event.

3. The system of claim 2, wherein receiving at least one modified bet parameter comprises receiving an odds value corresponding to the selected event.

4. The system of claim 3, wherein the odds value is based on the point spread value.

5. The system of claim 1, wherein transmitting at least one bet parameter corresponding to the selected event comprises obtaining the at least one bet parameter corresponding to the selected event from a desired betting institution.
